(19) United States
(12) Patent Application Publication
(10) Pub. No.: US 2009/0216502 A1
(43) Pub. Date: Aug. 27, 2009

(54) Carrier Design System

(76) Inventor: William John Booth, Westminster, CO (US)

Correspondence Address: JACKSON ESQUIRE;ROGER A. JACKSON, 209 KALAMATH STREET, UNIT 9, DENVER, CO, 80223-1348, US

(21) Appl. No.: 12/036,112

(22) Filed: Feb. 22, 2008

(51) Int. Cl. G06F 17/50

(52) U.S. Cl. 703/1

(57) ABSTRACT

An article of manufacture and method is disclosed to design an interior space having a plurality of components that includes displaying a plurality of interior design elements each having a common first attribute within a first attribute group, with the first attribute associated with a first interior space component. Further, the method of designing the interior space includes displaying a plurality of interior design elements each having a common second attribute within a second attribute group, with the second attribute associated with a second interior space component. Continuing, the method of designing the interior space includes selecting one the interior design elements from each group defined by the first attribute and second attribute. In addition, displaying each of the selected interior design elements from the first and second attribute groups on their respective associated first and second interior space components, all within the interior space.

### TECHNICAL FIELD

The present invention generally relates to a carrier design system for coordinating a multitude of visual colors and patterns for the design of a carrier. More particularly, the present invention uses an interactive graphic display based upon typical common carrier interior mediums such as buses, coaches, trains, tramway cars, transportation limousine cars, and the like for selecting coordinating carrier interior design elements. These elements would include materials, patterns, and colors for fabric, floor coverings, sidewalls, ceilings, handrails, and other visual elements, and then subsequently visually perceiving how a given combination would look together as a complete carrier interior prior to either re-selection of selected interior elements or completing final selection of the carrier interior elements. The carrier design system could be utilized in a number of mediums; such as being stored online for general or restricted public use or on a machine readable medium, CD/DVD-ROM, flash drive, hard disc drive or any other medium of the like with appropriate storage capacity.

### BACKGROUND OF INVENTION

Public transportation is a growing niche in our ever-changing world. In an age of rising oil prices and increasing environmental awareness, more people are realizing the impact their daily choices have on the earth as a living environment. One area that this impact is especially publicized in is the use of personal transportation. As people begin to understand how rapidly the environment is changing in an unfavorable manner and the economic and time saving advantages of using public transport, an ever increasing number of individuals will turn to public transportation for their daily needs.

Public transportation has an increasing responsibility, then, to court those people who have previously shunned it. People cite many reasons for dislike of public transportation, including its reputation as being only for people who are poor and cannot afford personal transportation and the general unattractiveness or an “institutional feel” i.e., the blandness of design of the carriers, especially relating to the carrier interior. As more people from all walks of life and varying economic levels start choosing public transportation due to its economic and environmental benefits, hopefully the former reason of unattractiveness will dissipate. The psychological dislike of the interior design of public transportation carriers can and should be taken seriously by the manufacturers and the municipal entities or other organizations that setup, operate, and maintain the public transit systems. By coordinating the interior design and making the carriers more aesthetically appealing, users of the carriers will feel more welcomed and will be more likely to choose public transportation in the future with the end result being individual time and cost savings in addition to the environmental benefits that everyone enjoys.

The interior design of common or public transit vehicles is generally quite plain or bland, evoking a certain sameness between carrier interiors. Fabric used on seats may incorporate some color, but for other fixtures, neutral colors and materials, such as grays, blacks and stainless steel, are the norm. For people who use these modes of public transportation, the color scheme may seem stark and unappealing. For the manufacturers of the transportation carriers, it is difficult to figure out how different color combinations will look together within a carrier prior to construction of the carrier. Thus, neutral color schemes are currently generally conservatively or unimaginatively chosen by the owners of such carriers prior to construction of the carrier to lessen the possibility of an unappealing color clash being without the benefit of a complete visual perception of the carrier interior prior to committing to the interior design element's selection and purchase, because of course once the selected color components are ordered, it is very difficult to change them, thus this motivates very little “creativity” in the interior design of carriers.

As digital technology continues to advance, interactive graphic displays also continue to gain in popularity. Such graphic displays include those with the ability to alter images, such as those that can change the appearance of a singular item, such as of piece of clothing. As the internet continues to rise in public utility and its ability to simplify common activities, versatility of these graphic displays becomes increasingly important. Online shopping is one area of internet use where graphic arts have revolutionized the industry. A typical prior art example is in United States patent application publication number US 2005/0177453 A1 to Anton et al. In Anton et al., a computer-based system for facilitating the customization of consumer products through a database of customizable information which can be accessed by an at-home consumer is disclosed. Anton et al. further discloses a method for ordering the customized products. Anton et al.'s system discloses the design of a single item, however, not how it would coordinate this single item with other pieces of clothing or accessories to be worn, i.e. not by having “intelligence” in suggesting a way to put different items together in a composite outfit.

Similar to Anton et al.'s system is in looking at U.S. Pat. No. 6,414,693 B1 to Bergen et al. Bergen et al. discloses a method for interaction of a client computer with a supplier database to create a customized backpack-type bag. In Bergen et al., clients log in under a password protected system and are then allowed to choose an item for customization from a database. Further in Bergen et al., an image of the chosen object is then displayed, and a graphic image can be chosen from another database. Once a graphic image is chosen, it will be displayed in such a way as to appear as a part of the chosen object, allowing clients of Bergen et al.'s system to preview a sample of a fully customized product prior to purchase. Bergen et al.'s system is used for the customization of a single object and does not teach how to visually coordinate more than one piece on a stand alone basis.

Another interactive graphic display is described in U.S. Pat. No. 7,146,576 B2 to Chang et al. Chang et al. discloses an apparatus and method for browsing a plurality of data objects represented by images displayed within a three-dimensional environment. In Chang et al., a user-selected scheme can be chosen such that images of the data objects are placed in a certain arrangement and by changing the scheme, the arrangement of the data objects will also be rearranged. Chang et al.'s system relates most commonly to the arena of online shopping, wherein each scheme would represent a different type of shop. Each of these types of shops as described in Chang et al. would be expected, in the non-virtual world, to have a certain type of layout, and Chang et al. seeks to simulate that layout in the virtual world, to make online shopping more consumer friendly, and is unique due to its determination of the relative size of a partitioned area according to the number of objects within a group. Chang et al. does not seek to change the aesthetic appearance of an interior space, but merely the layout of it.

Looking further into the on-line shopping/virtual modeling prior art area, an example would be in U.S. Pat. No. 6,901,379 B1 to Balter et al. In Balter et al., disclosed is an online shopping system wherein a digital image of the consumer themselves can be viewed by the consumer, as well as other users of the system. Balter et al. further discloses a method for allowing the digital image of the consumer to be used as a virtual model for items of clothing. Balter et al. allows the virtual image of the consumer wearing the item of clothing to be shared with other users for feedback on whether the chosen item should be purchased. Balter et al. allows for one or two items to be visualized within a certain image, but does not teach the actual coordination of the different items. Balter et al. also does not disclose a method for visual perception of more than one material at any point in time.

Another example of prior art in the field of graphic interactive displays is in looking at U.S. Pat. No. 7,062,722 B1 to Carlin et al. Carlin et al. discloses a network-linked interactive three-dimensional composition and display of objects offered for sale within a viewer-selected scene for both advertisement and as a point of sale. Carlin et al.'s method permits a customer to place a single item or item components within a selected view of the customer's choosing. The view in Carlin et al. could be either selected from a variety of pre-composed images or an image uploaded by the customer. According to Carlin et al., after the customer has selected the most appropriate image for their needs, an object for purchase can be placed within the selected image to show the customer how it would look in the surroundings depicted in the image. While Carlin et al. may help to determine whether a customer should purchase an object based on its appearance within a chosen scene, it does not teach the color coordination of several items that can be switched out at any time. Thus, Carlin et al. does not contain any logic to control for coordination of items to one another.

Further, U.S. Pat. No. 6,122,391 to Ringland et al. disclosed is a system for selecting decorative materials for home or office interior design to be stored on an inexpensive medium such as a CD-ROM. Ringland et al.'s system uses spectrophotometric color analysis of the decorative materials included in the database. The spectrophotometric color analysis of wallpaper patterns, drapery materials, floor coverings and paint described in Ringland et al.'s system is then referenced to a color standard system. Ringland et al.'s system allows for a quick selection of materials, which will match a given item input into the system. Images of the selected color samples can then be projected side by side on a display to allow a user to see how they will interact. Further in Ringland et al.'s system, an interactive graphic display of a room image can be altered to show the chosen decorating materials. Ringland et al.'s primary purpose is to decrease costs and problems associated with the use of traditional interior design sample books. The CD-ROM system disclosed in Ringland et al. is an inflexible system, especially when it comes to system updates and newly available patterns. Ringland et al. also is set up only for spectrophotometrically matching colors, but does not extend further to the coordination of non-matching colors. Ringland et al. briefly mentions the rendering of the patterns onto a room image, but does not teach that specific feature. Thus Ringland et al., utilizes for instance a wall paper manufacture's recommended color grouping of a wall pattern, border, trim, and the like, with Ringland et al.'s, program displaying these manufacturer's color/pattern groupings, along with the likes of window coverings, floor coverings, paints, and the like, however, Ringland et al., does not teach the coordination of these diverse components of for example wall paper and floor covering for color coordination.

Continuing in another primarily wall covering pattern matching program in the prior art, in U.S. Pat. No. 5,291,395 to Abecassis disclosed is a system and method for presenting, selecting and retrieving samples of wall covering. Abecassis's system utilizes an input card or brochure incorporating a chart of color-range cells from which a user can select favorite options. From the user-selected options in Abecassis, a list of design component patterns of a certain type of materials, such as wall coverings, which match the selected criteria, is generated. Abecassis is designed to enable maximum consumer choice of wall coverings only and does not address coordination of two or more different items of wall covering. Abecassis also is limited to wall coverings and does not teach a method for viewing a whole interior setting of any kind.

Another example from the prior art, U.S. Pat. No. 7,072,733 B2 to Magee et al., discloses an interactive system and method for design, customization and manufacture of decorative textile substrates, such as carpet. Magee et al.'s system uses an interface, which allows remote access to a user for customizing textile designs by applying colorant applicators through a communications network. Magee et al.'s system further digitizes the image the user has created for a realistic representation of what the textile will look like, and also potentially allow for the user to order their own custom-designed textiles. Magee et al.'s system is primarily used to order custom designs for carpet or other substrates, and therefore would not be useful in the coordination of fabrics and other materials in a carrier. Also, because Magee et al.'s system is predominantly used for floor covering, no graphic representation of a room is disclosed.

Further, in U.S. Pat. No. 6,664,972 B2 to Eichel et al., a system for the automated selection of interior design surface treatments for residential or commercial interior spaces is disclosed. Eichel et al. begins by choosing a multitude of patterns from a stored set of patterns by utilizing user-selected search criteria. Eichel et al. then creates a storyboard of possible combinations of the surface treatments using the patterns chosen through use of the user-selected search criteria. Eichel et al. could be used to generate a multitude of possible combinations of patterns. Eichel et al. is designed particularly for use by interior designers, architects, and the like, who will be able to see how two patterns interact with each other. Eichel et al. does not teach the patterns to be superimposed on simulated images or to see how the patterns look on a specific piece of furniture or how it will look in combination with other pieces of furniture of different patterns. Therefore, no coordination of specific interior design surface treatments is taught in Eichel et al. As the Eichel et al. system is primarily an electronic catalog of a multitude of component floor coverings, wall coverings, and upholstery with search capabilities for component availability; however, there is no teaching of a selection coordination of the various components with one another, nor is there any teaching of a composite visual display of all of the previously mentioned components in a room setting for a complete interior design scheme visualization.

What is needed is a system which allows for the visual perception of the interior of a multitude of different types of carriers, wherein coordination of colors, textures, patterns, fabrics and surfaces, including non-fabric surfaces, is possible specifically within each of the types of carriers. To be able to visually perceive the actual interior of a carrier, equipped with the precise poles, walls, flooring, rails, ceiling, seat frames, and seat fabrics would be invaluable to manufacturers attempting to produce visually-pleasing public transportation carriers. Even more useful would be a system which would give suggestions to help fully coordinate other elements of the carrier interior when one of the other elements was chosen. A system such as this would have the potential to further improve the public's perception of public transportation, and therefore work to increase the number of people using the public transportation systems. Further, for the benefit of the carrier manufacturer and their end customer having the ability to visualize ahead of time the substantially complete interior of their carrier coach or car with a multitude of component fabric patterns, colors, and textures, for the seats, seat frames, floors, walls, ceilings, poles, rails, and the like to select from, while being able to visualize each and every combination desired prior to committing to purchase a particular combination of component fabric patterns, colors, and textures for the carrier interior. In addition, it is desired that the system assist in coordinating a particular grouping of component fabric patterns, colors, and textures based upon a user selecting one of the aforementioned components, such as a particular pattern and then having the system put together a suggested color group that is either matching in various color shades or from a grouping of different colors that are complementarily coordinated to assist with the choosing of the remaining components to form a coordinated and aesthetically pleasing proposed interior for the carrier with colors that are appealing and enhancing to the carrier interior. Also, the system could generate a bill of materials once the final selections had been made for the carrier interior, to more easily facilitate the progress in manufacturing the carrier coach or car.

### SUMMARY OF INVENTION

The present invention is an article of manufacture to facilitate an independent method of designing an interior space having a plurality of components that includes displaying a plurality of interior design elements each having a common first attribute within a group defined by the first attribute, with the first attribute being associated with a first interior space component. Further, the method of designing the interior space includes displaying a plurality of interior design elements each having a common second attribute within a group defined by the second attribute, with the second attribute being associated with a second interior space component. Continuing, the method of designing the interior space includes selecting one the interior design elements from each group defined by the first attribute and the second attribute. In addition, the method of designing further includes displaying each one of the selected interior design elements from the first attribute group and the second attribute group on their respective associated first interior space component and second interior space component, all within the interior space.

These and other objects of the present invention will become more readily appreciated and understood from a consideration of the following detailed description of the exemplary embodiments of the present invention when taken together with the accompanying drawings, in which;

### BRIEF DESCRIPTION OF THE DRAWINGS

With initial reference to FIG. 1, shown is a summary schematic flow diagram of the carrier design method, showing the major steps of the method including a display of an interior space, a selection of an interior design element, creating a visual perception of the interior design element within the interior space, and optional coordination of the interior design elements by selecting an interior design element, through a set of criterion to aesthetically match the interior design elements;

FIGS. 2, 3, and 4 taken together comprise a more detailed schematic flow diagram of the carrier design method, particularly with a plurality of interior design elements to choose from that include interior space components of seats having interior design element attributes of fabric patterns, textures, and colors, and further including interior design element attributes of colors and textures for the interior space components of seat frames, segmented pathway and non-pathway flooring, upper and lower sidewalls, ceiling, handrails, partitions, and stanchions and further again with the optional coordination of the entire interior design by selecting an interior design element or plurality of interior design elements for a suggested design theme;

FIG. 5 shows a perspective view of the carrier interior space including the plurality of interior design elements to choose from that include interior space components of seats having interior design element attributes of fabric patterns, textures, and colors, and further including interior design element attributes of colors and textures for interior space components of seat frames, segmented pathway and non-pathway flooring, upper and lower sidewalls, ceiling, partitions, handrails, and stanchions plus further again with the optional coordination of the entire interior design by selecting an interior design element or plurality of interior design elements for a suggested design theme;

FIG. 6 includes the typical manually selecting function frame commands of the interior design element choices as shown in FIG. 5, as FIG. 5 had the function frame commands removed from FIG. 5 for clarity;

FIG. 7 being similar to the perspective shown in FIG. 5, however, selectably optionally illustrates the visual perception of the interior design of the carrier interior space not including the seats, handrails, and stanchions, to better visualize how the partitions, pathway and non-pathway flooring, ceiling, and upper and lower sidewalls will coordinate in an interior design sense to one another;

FIG. 8 for clarity includes a portion of the typical example of the manual selecting function frame that illustrates the method of selecting the interior design elements, not including the methods of interior design element selection for the seats, handrails, and stanchions;

FIG. 9 shows a perspective of the optional view, similar to FIG. 7, wherein FIG. 9 illustrates the visual perception of a selected single or plurality of interior space components displayed with their associated interior design elements attributes independent of the carrier interior space, wherein in FIG. 9 in particular, the seats and seat frames only are shown, to better visualize how the seat fabric and seat frame will coordinate with each other in an interior design sense absent the distraction of the plurality of interior design elements being displayed within the carrier interior space; and

FIG. 10 shows a portion of the typical manual selecting function frame again for clarity purposes and being in conjunction with the optionally selected interior design elements as described in FIG. 9, wherein FIG. 10 displays a portion of the typical manual selecting function frame for what is displayed in FIG. 9 that illustrates the method of selecting the interior design element attributes of the seat assembly only which includes fabric color, fabric pattern, and seat frame color.

### REFERENCE NUMBERS IN DRAWINGS

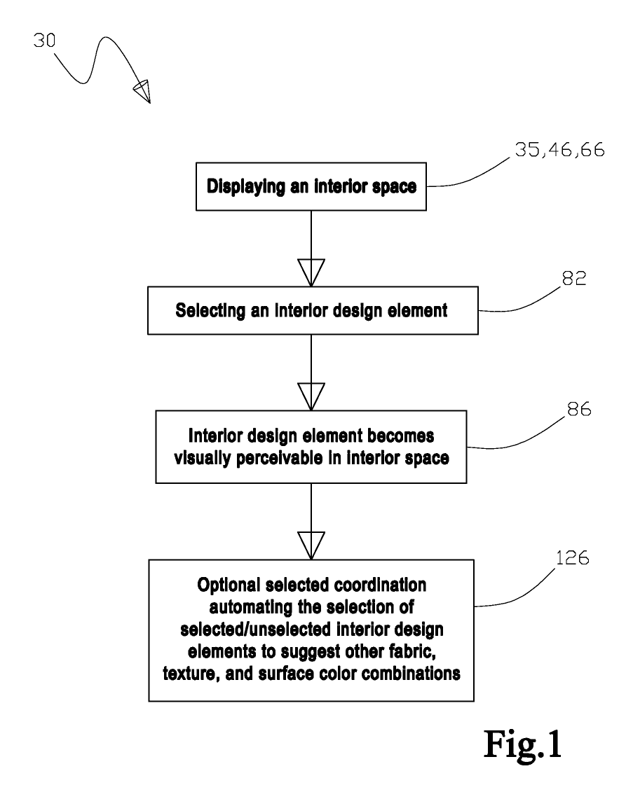

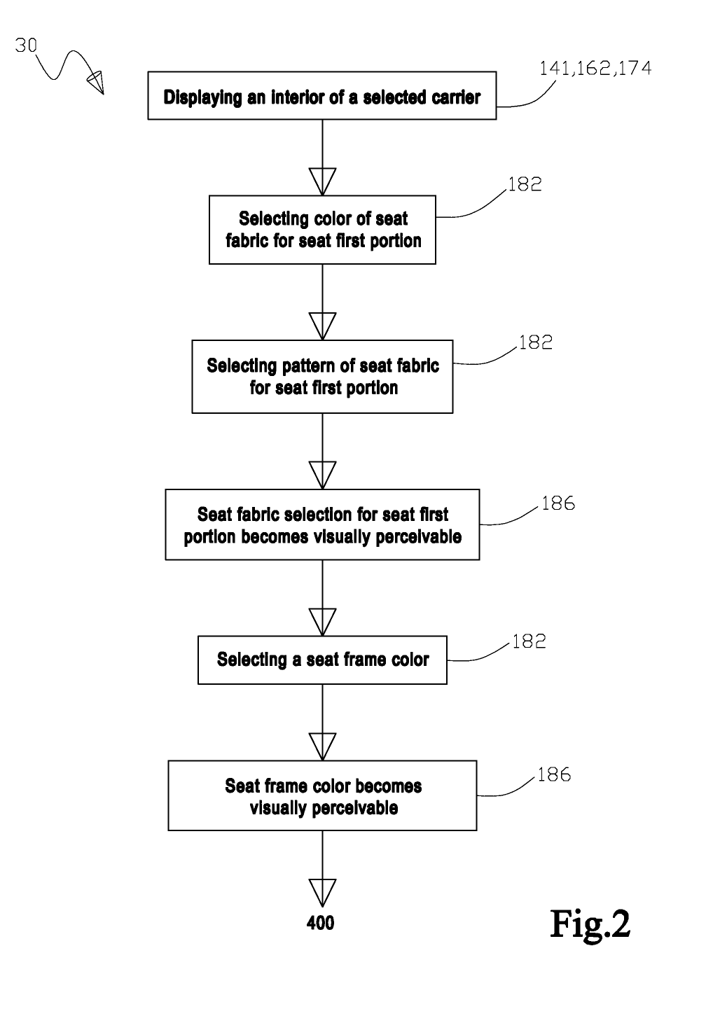

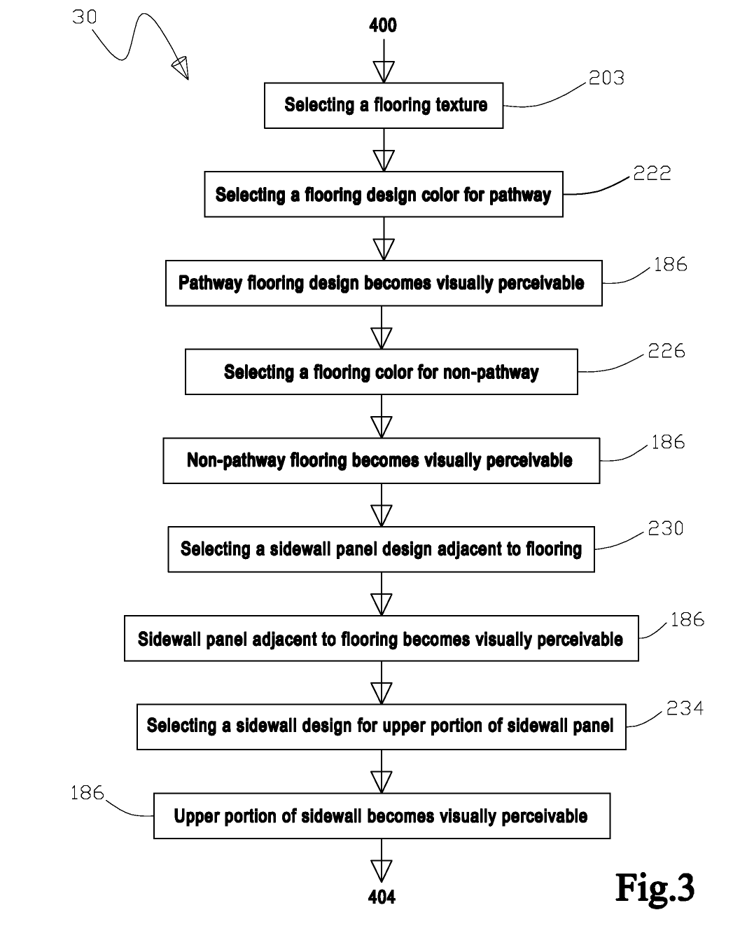

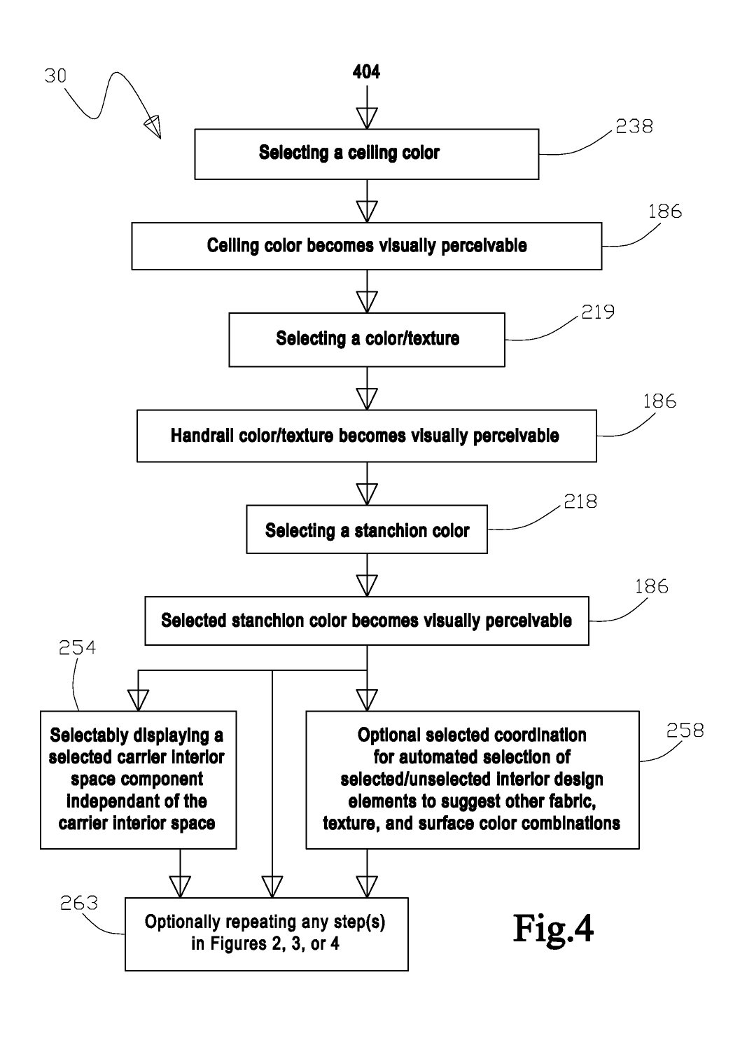

30 Method of designing an interior space 34
34 Interior space
35 Displaying an interior space 34
36 Manual selection function frame
38 Components of the interior space 34
42 Interior design elements having a common first attribute 50
46 Displaying a plurality of interior design elements 42 having a common first attribute 50
50 Common first attribute of interior design elements 42
54 Group defined by first attribute 50
58 First interior space component
62 Interior design elements having a common second attribute 70
66 Displaying a plurality of interior design elements 62 having a common second attribute 70
70 Common second attribute of interior design elements 62
74 Group defined by second attribute 70
78 Second interior space component
82 Selecting one each interior design element 42 and 62
86 Displaying selected interior design elements 42 and 62
90 Interior design elements having a common third attribute 98
94 Displaying a plurality of interior design elements 90 having a common third attribute 98
98 Common third attribute of interior design elements 90
102 Group defined by third attribute 98
106 Third interior space component
110 Selecting interior design element 90
114 Displaying selected interior design element 90
118 Selectively displaying a selected interior space component 58/78 and the like
122 Selecting manually one interior design element 42 or 62 and the like
126 Coordinating a pair of interior design elements 42 and 62 by automatically selecting the interior design element 42 or 62 that was not previously manually selected
130 Displaying the manually selected interior design element 42 or 62 and the automatically selected interior design element 42 or 62
134 Selecting manually one of the interior design elements 42, 62, or 90
138 Displaying the manually selected interior design element 42, 62, or 90 and the automatically selected interior design elements 42, 62, and/or 90
141 Displaying the carrier interior space
142 Carrier interior space
143 Interior design element associated with color 202, texture 203, and component 214
144 Interior design element associated with color 202, texture 203, and component 222
145 Interior design element associated with color 202, texture 203, and component 226
146 Fabric styles
147 Interior design element associated with color 198, texture 203, and component 230
148 Interior design element associated with color 198, texture 203, and component 234
149 Interior design element associated with color 194, texture 203, and component 219
150 Plurality of different attributes for the fabric styles 146
151 Interior design element associated with color 198, texture 203, and component 238
154 Fabric style 146 attribute of color for the interior design element
158 Fabric style 146 attribute of pattern for the interior design element
159 Fabric style 146 attribute of texture for the interior design element
162 Displaying a plurality of fabric styles 146
166 First carrier interior space component
170 Surface colors
174 Displaying a plurality of surface colors 170
178 Second carrier interior space component
182 Selecting manually one fabric style 146 and/or one surface color 170
186 Displaying each selected fabric style 146 and/or each selected surface color 170
190 Plurality of different attributes for the surface colors 170
194 Surface color 170 attribute of a bright color grouping for the interior design element
198 Surface color 170 attribute of a pastel color grouping for the interior design element
202 Surface color 170 attribute of a basic color grouping for the interior design element
203 Surface color 170 attribute of a texture for the interior design element
206 Plurality of carrier interior space components
210 Carrier interior space component of a seat frame
214 Carrier interior space component of a partition
218 Carrier interior space component of a stanchion
219 Carrier interior space component of a handrail
222 Carrier interior space component of a center floor or pathway
226 Carrier interior space component of a side floor or non-pathway
230 Carrier interior space component of a lower side panel adjacent to the side flooring 226
234 Carrier interior space component of an upper side panel
238 Carrier interior space component of a ceiling
242 Carrier interior space component of a seat cushion
246 Carrier interior space component of a seat back cushion
250 Selecting a plurality of surface colors 170
254 Selectively displaying a selected carrier interior space component independent of the carrier interior space 142
258 Coordinating the fabric styles 146 and surface colors 170 by automatically selecting the fabric style 146 or surface color 170 that was not previously manually selected or suggesting a coordinated grouping of the selected fabric styles 146 and surface colors 170
262 Displaying the manually selected fabric styles 146 and surface colors 170 and the automatically selected fabric styles 146 and surface colors 170
263 Repeating any selecting/displaying or coordinating step
266 Generating a bill of materials list 270
270 Bill of materials list
274 Article of manufacture
278 Machine accessible medium
282 Instructions for enabling a processor to perform
400 FIG. 2 flowchart continuation to FIG. 3
404 FIG. 3 flowchart continuation to FIG. 4

### DETAILED DESCRIPTION

With initial reference to FIG. 1, shown is a summary schematic flow diagram of the carrier design method 30, showing the major steps of the method 30 including a display 35 of an interior space 34, a selection of an interior design element 42, 62, and/or 90 creating a visual perception of the broad based interior design element 42, 62, and/or 90 within the interior space 34. Further FIG. 1 shows the optional coordination 126, 258 of the broad based interior design elements 42, 62, and/or 90 by automatically selecting an interior design of the broad based elements 42, 62, or 90, through a set of criterion to aesthetically match the interior design elements. Continuing, in FIGS. 2, 3, and 4 taken together comprise a more detailed schematic flow diagram of the carrier design method 30, particularly with a plurality of detailed individual interior design elements 154, 158, and 159, to choose from that include interior space components 38 of seats, being carrier interior space component 242 for the seat cushion, and 246 for the seat back cushion. In addition, in FIGS. 2, 3, and 4 include detailed individual interior design elements 154, 158, and 159 with attributes 150 of fabric patterns 158, fabric textures 159, and fabric colors 154, and further including interior design element attributes 190 of surface colors 194, 198, or 202 and textures 203 for a plurality of interior space components 206 including seat frames 210, segmented pathway 222 and non-pathway 226 flooring, upper 234 and lower 230 sidewalls, ceilings 238, handrails 219, partitions 214, and stanchions 218. Further again, in FIGS. 2, 3, and 4 with the optional coordination 126, 258 of the detailed individual interior design elements 154, 158, 159, 194, 198, 202, and 203 by automatically selecting the aforementioned interior design element or plurality of interior design elements for a suggested design theme through a set of criterion to aesthetically match the interior design elements.

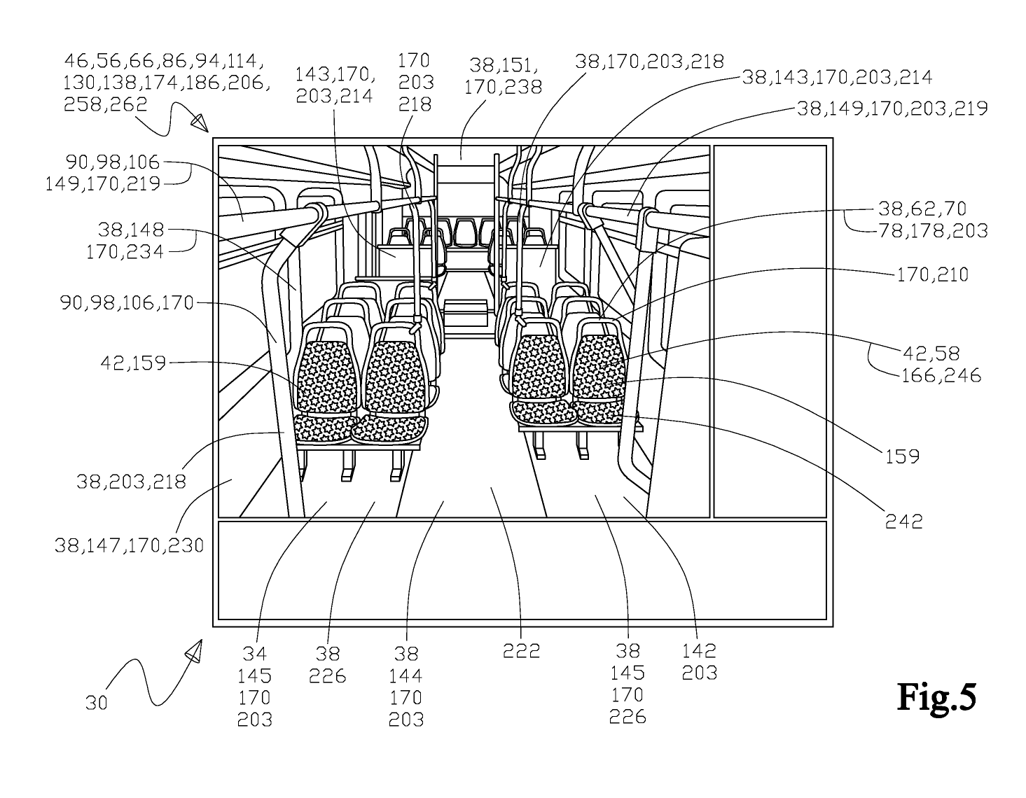

Further, FIG. 5 shows a perspective view of the carrier 142 interior space 34 including the plurality of interior design elements 154, 158, 159, 194, 198, 202, and 203 to choose from that include interior space components 206 of seats 242 for the seat cushion and 246 for the seat back cushion having interior design element attributes of fabric patterns 158, textures 159, and colors 154. Also, FIG. 5 further including interior design element attributes 190 of colors 194, 198, or 202 and textures 203 for interior space components 206 of seat frames 210, segmented pathway 222 and non-pathway 226 flooring, upper 234 and lower 230 sidewalls, ceilings 238, partitions 214, handrails 219, and stanchions 218. Further again, in FIG. 5 with the optional coordination 126, 258 of the detailed individual interior design elements attribute groups 154, 158, 159, 194, 198, 202, and 203 by automatically selecting the aforementioned interior design element or plurality of interior design elements for a suggested design theme through a set of criterion to aesthetically match the interior design elements.

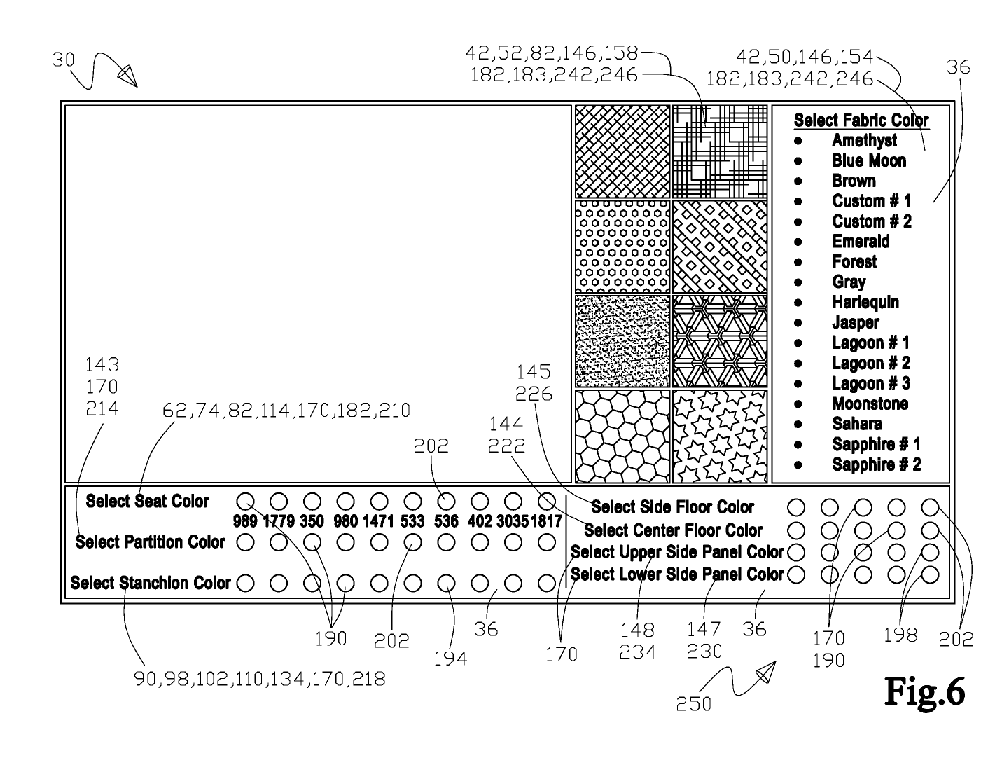

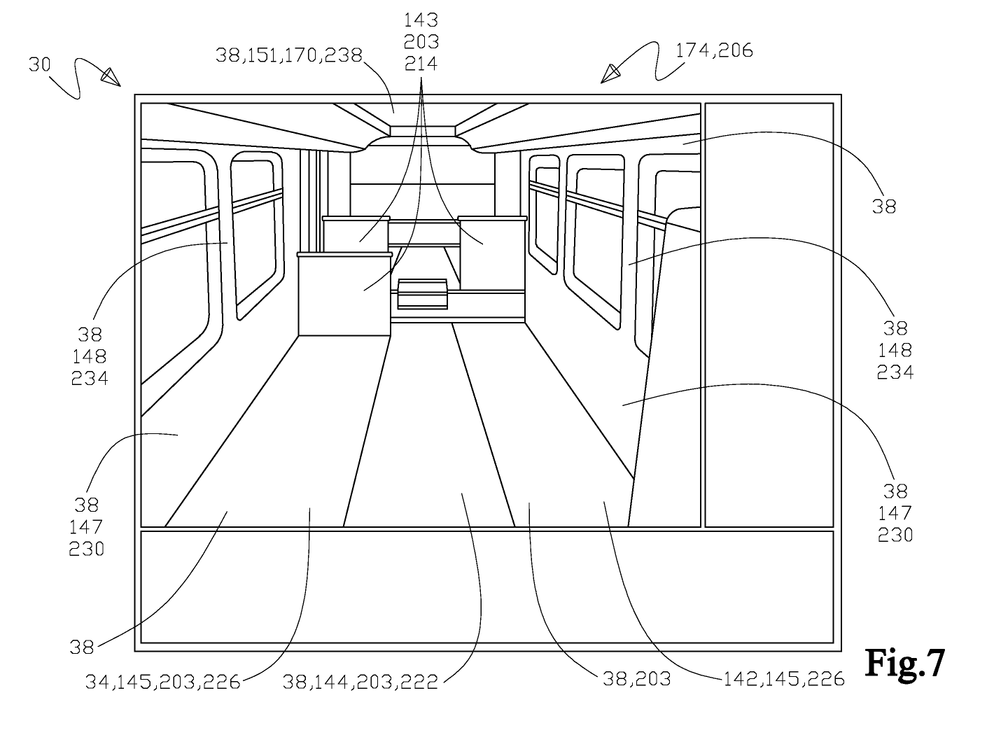

Moving to FIG. 6 included is the typical manually selecting function frame 36 commands of the interior design element 154, 158, 159, 194, 198, 202, and 203 choices as shown in FIG. 5, as FIG. 5 had the function frame 36 commands removed from FIG. 5 for clarity. Next, FIG. 7 being similar to the perspective shown in FIG. 5, however, selectably optionally illustrates the visual perception of the interior design of the carrier interior space 142 not including the seats 242 and 246, handrails 219, and stanchions 218, to better visualize how the partitions 214, pathway 222 and non-pathway 226 flooring, ceilings 238, and upper 234 and lower 230 sidewalls will coordinate in an interior design sense to one another. Noting that this option of selectively displaying various interior space components 206 each individually or in selected groups with or without the carrier interior space in the perspective background, wherein the components 206 are each adorned with their selected respective interior design elements assists in visually perceiving desirable aesthetics for the decision on the carrier interior design.

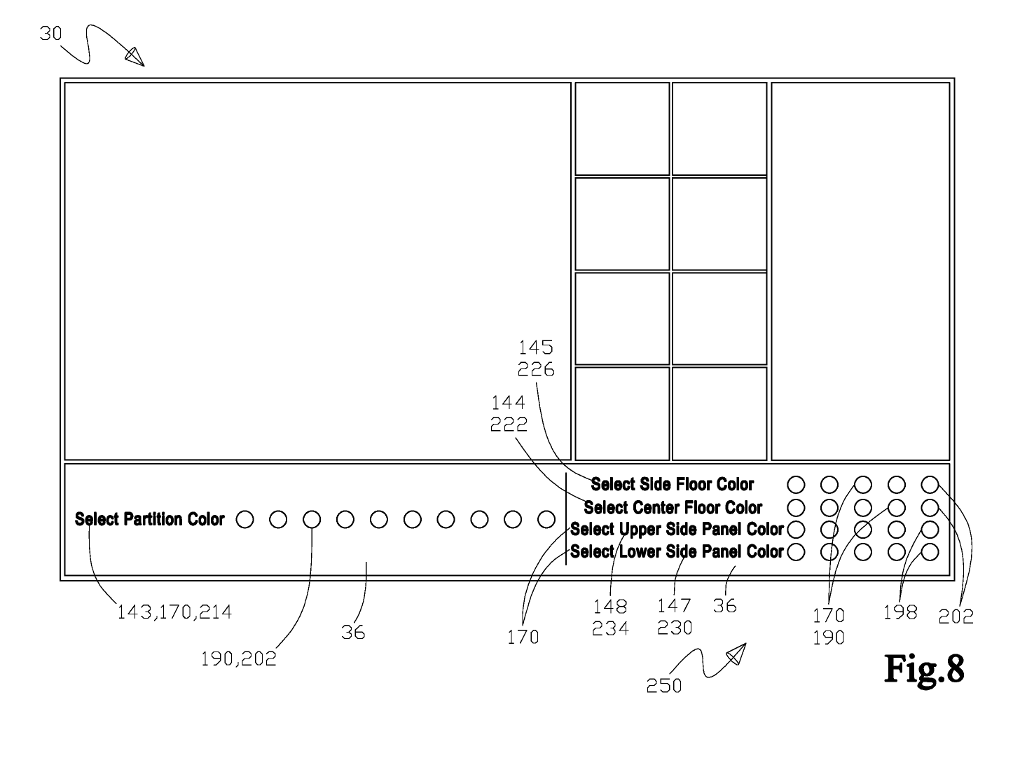

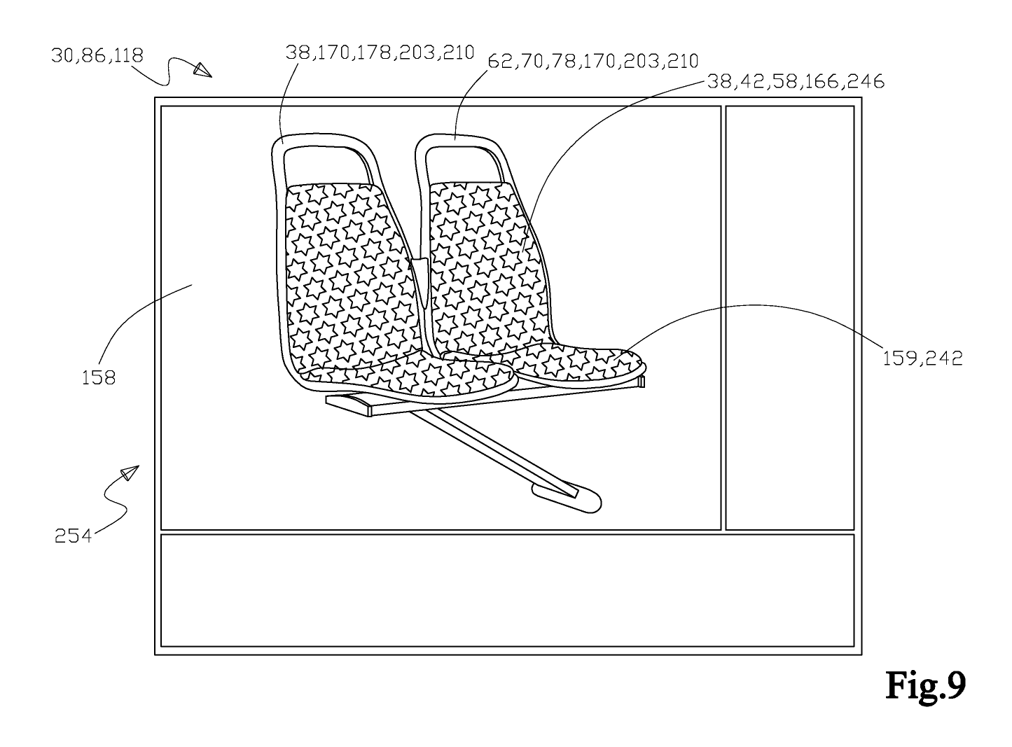

Moving onward, FIG. 8 for clarity includes a portion of the typical example of the manual selecting function frame 36 that illustrates the method of selecting the interior design elements as physically shown in FIG. 7, that includes partitions 214, pathway 222 and non-pathway 226 flooring, ceilings 238 (not shown), and upper 234 and lower 230 sidewalls will coordinate in an interior design sense to one another. Noting that as identified in FIG. 7, not including the methods of interior design element selection for the seats 242 and 246, handrails 219, and stanchions 218. Continuing, FIG. 9 shows a perspective of the optional view, similar to FIG. 7, wherein FIG. 9 illustrates the visual perception of a selected single interior space component of the seat frame 210 including component 242 for the seat cushion and component 246 for the seat back cushion or alternatively a plurality of selected interior space components 206 could be shown. These selected components could include all or a portion of the following components including seat frames 210, segmented pathway 222 and non-pathway 226 flooring, upper 234 and lower 230 sidewalls, ceilings 238, handrails 219, partitions 214, and stanchions 218 that could be displayed with their associated interior design elements 150 of fabric patterns 158, fabric textures 159, and fabric colors 154, and further including interior design element attributes 190 of surface colors 194, 198, or 202 and textures 203. With these selected adorned components being displayed independent of the perspective background of the displayed carrier interior space 141, wherein in FIG. 9 in particular, the seats 242 and 246 and seat frame 210 only are shown, to better visualize how the seat fabric 146 and seat frame 210 will coordinate with each other in an interior design sense absent the visual distraction of the plurality of interior design elements being displayed within the carrier interior space 141.

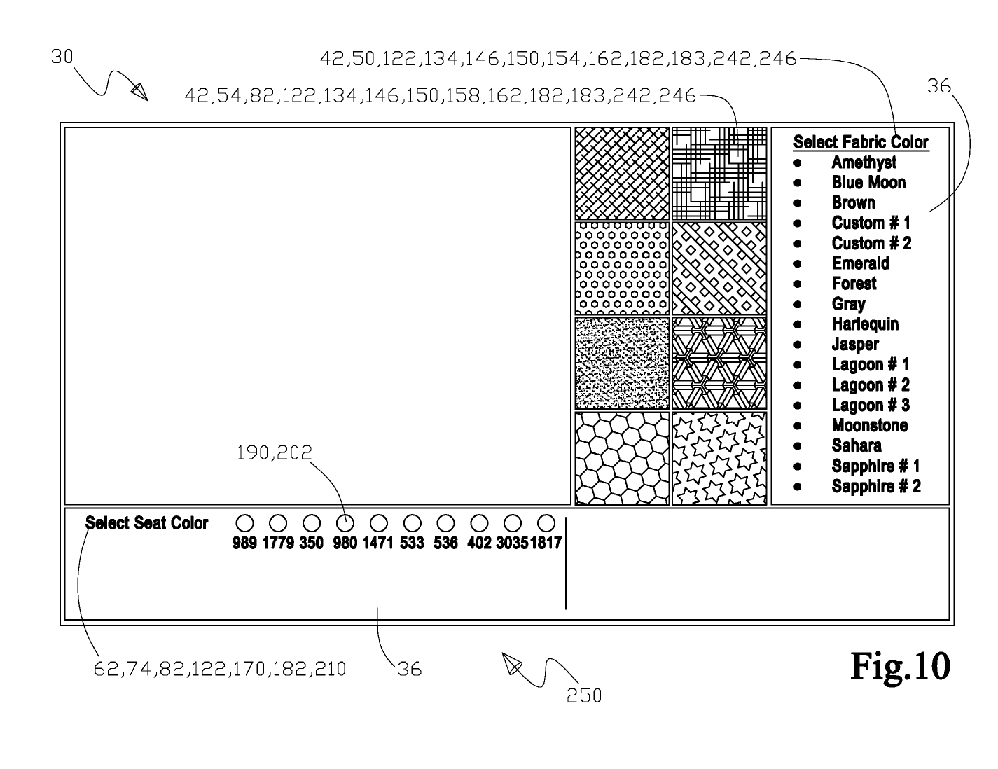

Further to FIG. 10 shown is a portion of the typical manual selecting function frame 36 again for clarity purposes and being in conjunction with the optionally selected interior design elements as described in FIG. 9. Wherein FIG. 10 displays a portion of the typical manual selecting function frame 36 for what is displayed in FIG. 9 that illustrates the method of selecting the interior design element attributes 154, 158, 159, 194, 198, 202, and 203 of the seat assembly components 210, 242 and 246 only which includes fabric color, fabric pattern, fabric texture seat frame color, and seat frame texture.

Broadly the present invention is a method 30 of designing an interior space 34 having a plurality of components 38, that includes displaying 46 a plurality of interior design elements 42 each having a common first attribute 50 within a group defined by the first attribute 54, with the first attribute 50 being associated with a first interior space component 58. Further, the method 30 of designing an interior space 34 also includes displaying 66 a plurality of interior design elements 62 each having a common second attribute 70 within a group defined by the second attribute 74, with the second attribute being associated with a second interior space component 78. Continuing, the method 30 also includes selecting 82 one the interior design elements 42 and 62 respectively from each of the groups defined by the first attribute 50 and the second attribute 70 and a next step of displaying 86 each one of the selected interior design elements 42 and 62 from the first attribute 50 group 54 and the second attribute 70 group 74 on their respective associated first interior space component 58 and second interior space component 78, all within the interior space 34. The interior space 34 can be any of a multitude of backgrounds ranging from a typical room of a house, to an office setting, or as shown the interior of a common carrier 142, such as best shown in FIGS. 5 and 7, further the interior space 34 could be any space that is displayed for the benefit of the user in helping them to visually perceive their selected interior design elements.

The interior design element 42 for example could be a could be a fabric style 146 with the attributes of color 154, pattern 158, or texture 159 that are associated with the first interior space component 58 of the seat 242 and/or seat back 246. Wherein the attribute group of color 154 for the interior design element 42 of fabric style 146 could include a plurality of colors for the display 50 of the plurality of interior design elements 46, see for example FIGS. 5 and 6 for the display 50 and the first interior space component 58 of the seat 242 and/or seat back 246 respectively. Moving forward, the interior design element 62 second attribute 70 could be the pattern 158 with a plurality of attribute patterns 158 displayed 66 that are also associated with the first interior space component 58 of the seat 242 and/or seat back 246. Or alternatively, the interior design element 62 second attribute 70 could be the surface color 170 with a plurality of attribute colors 202 as displayed in FIGS. 6 and 10, that are associated with the second interior space component 78 of the seat frame 210, as best shown in FIGS. 5 and 9. Thus, the interior design elements are typically numerous within a group sharing a common attribute as described above, i.e. a number of different patterns 158 forming interior design elements within the attribute of patterns and further this attribute of patterns associated with an interior space component of seat 242 and seat backs 246. Following this, the interior design elements could be any selectable elements that naturally fall within an attribute group, i.e. being different, however, sharing some common features following the examples above, with the attribute group being associated with any interior design component, with the possibility that multiple attribute groups could be associated with a single interior design component.

In addition, for the method 30, a step can be optionally added of displaying 94 a plurality of interior design elements 90 each having a common third attribute 98 within a group 102 defined by the third attribute 98 that is associated with a third interior space component 106. Wherein one of the interior design elements 90 is selected 110 from the third attribute group 102 and further displaying 114 the selected interior design element 90 from the third attribute group 102 on the third interior space component 106 within the interior space 34. Thus the interior design element 90 for example is a surface color 170 with the attribute 194 of a bright color grouping associated with the interior space component 106 of the stanchion 218 as best shown in FIGS. 5 and 6. However, the additional interior design element 90, third attribute group 102, and the third component 106 could be something other than the example surface color 170, from attribute 194, on the same component of the stanchion 218, resulting in other colors, textures, patterns, and the like with various attributes on any number of different components. Although texture 159 for a fabric and texture 203 for a surface are not necessarily shown, they could be options for the method 30 as another option for an interior design element and having an attribute group of similar textures that would have applicability for instance on the stanchions 218 or flooring 222 or 226, wherein a rough surface texture for the functionality of improved safety due to a higher friction grip, for the hands of a rider on the stanchion 218 or for the rider's feet having better friction with the flooring 222 or 226 of the carrier interior 142.

As a further helpful option to the individual selecting interior design elements using the method 30, an additional step includes selectively displaying 118 a selected interior space component 58, 78, or the like, independent of the interior space 34, wherein the selected interior space components 58, 78, or the like is adorned with the selected interior design elements 42, 62, or the like that is associated with the selected interior space components 58, 78, or the like. This selective displaying 118 is best shown in FIG. 9 that illustrates the visual perception of a selected single interior space component which for example is the seat frame 210 including component 242 for the seat cushion and component 246 for the seat back cushion or alternatively any other single or plurality of other selected interior space components 206 could be shown also without the perspective of the interior space 34 background removed for clarity. These selected components could include all or a portion of the following components including seat frames 210, segmented pathway 222 and non-pathway 226 flooring, upper 234 and lower 230 sidewalls, ceilings 238, handrails 219, partitions 214, and stanchions 218 all that could be displayed with their associated interior design elements 150 of fabric patterns 158, fabric textures 159, and fabric colors 154. The selected components could further include interior design element attributes 190 of surface colors 194, 198, or 202 and textures 203. With these selected adorned components being displayed 118 independent of the perspective background of the displayed interior space 34 or more particularly the carrier interior space 141, wherein in FIG. 9 in particular, the seats 242 and 246 and seat frame 210 only are shown, to better visualize how the seat fabric and seat frame will coordinate with each other in an interior design sense absent the distraction of the plurality of interior design elements being displayed within the carrier interior space 141. Furthermore with the method 30, the steps of selecting 82 and displaying 86 as previously described can be repeated 263 as many times as desired until the user is satisfied with their interior design element selections.

Further, as another option to the method 30 for the selecting step 82 as previously described could be modified to a selecting step 122 that includes selecting manually one interior design element 42 or 62 from either the first attribute group 54 or the second attribute group 74. In conjunction with this, an added step of optionally coordinating 126 a pair of interior design elements 42 or 62 by selecting an interior design element 42 or 62 from the attribute group 54 or 74 that did not have an interior design element 42 or 62 previously selected from. Then a next step follows of displaying 130 manually selected interior design element 42 or 62 and the selected interior design element 42 or 62 on their respective associated first interior space component 58 and second interior space component 78, all within the interior space 34. Further, on the coordination 126 or more particularly the coordination 258 of the detailed individual interior design element attributes 154, 158, 159, 194, 198, 202, and 203 by selecting the aforementioned interior design element or plurality of interior design elements from the aforementioned attribute groups for suggested coordinating colors through a user optional additional software, such as the preferred Charten Software's ColorSkate program.

In other words, the optional coordination 126 or 258 is operational to help a user choose unselected interior design element(s) by selecting one or more interior design elements from their respective attribute groups as defined above associated with their particular interior space components or alternatively the coordination 126 or 258 step can help a user select all of the interior design elements according to a theme type criterion as an interior design suggestion for the carrier interior space 142. Therefore the individual using the method 30 could manually select from none to one short of all of the interior design elements available to select from and then utilize the optional coordination 126 or 258 step to automatically select from one to all of the interior design elements. Through the use of Charten Software's ColorSkate program, or another similar color coordination program, a user can import a particular color or colors from one or more interior design elements. The color coordination program would then create a palette of colors coordinating with the imported color. The user could then decide to choose all or a portion of these coordinating colors to help in the selection of further design elements.

Specifications for the preferred ColorSkate software:
Publisher: Charten Software
File Size: 4557 kb
Version: 1.43
Last Updated Nov. 2, 2007

Optionally, for the method 30, a step could be added of displaying 94 a plurality of interior design elements 90 each having a common third attribute 98 within a group 102 defined by the third attribute 98 that is associated with a third interior space component 106. Wherein an interior design element 42, 62, or 90 is manually selected 134 from one of the first 54, second 74, or third 102 attribute groups, wherein a plurality of interior design elements 42, 62, or 90 from their respective attribute groups 54, 74, or 102 and on their respective interior space components 58, 78, and 106 are displayed 138 from coordinating an automatic selection of the interior design elements 42, 62, and 90 from the attribute groups 54, 74, and 102 that did not have an interior design element previously manually selected. The method 30 can be enhanced to further design the carrier interior space 142 that includes displaying 162 a plurality of fabric styles 146, as best shown in FIGS. 6 and 10 that are associated with a first carrier interior space component 166, that is preferably the seat 242 and/or the seat back 246 as best shown in FIGS. 5 and 9. A next step of displaying 174 a plurality of surface colors 170, as best shown in FIGS. 6 and 10 associated with a second carrier interior space component 178, that is preferably the seat frame 210, as best shown in FIGS. 5 and 9. Further, a step of manually selecting 182 one fabric style 146 and one surface color 170 and a continuing step of displaying 186 each one of the selected fabric styles 146 and the selected surface colors 170 that are associated with their respective aforementioned carrier interior space components to visually perceive the carrier interior 142 with the selected fabric styles 146 and the selected surface colors 170.

Another optional step modification would concern the step of displaying 174 a plurality of surface colors 170 that is further segregated into a plurality of different attributes, with each attribute 194, 198, and 202 having a plurality of surface colors 170, with each said attribute 194, 198, and 202 associated with a specific carrier interior space component forming a plurality of interior space components 206, or more particularly the seat frame 210, the partition 214, the stanchion 218, the handrail 219, the floor 222 and 226, side panels 230 and 234, and optionally a ceiling 238, as best shown in FIGS. 5, 7, and 9. Wherein the selecting step further includes selecting 250 a plurality of surface colors 170, being a selection of a surface color 170 for each specific carrier interior space component, identified as interior space components or again more particularly the seat frame 210, the partition 214, the stanchion 218, the handrail 219, the floor 222 and 226, side panels 230 and 234, and optionally a ceiling 238.

A further added step is of selectively displaying 254 a selected carrier interior space component independent of the carrier interior space 142, wherein the selected carrier interior space components being any one, a portion or all of the seat 242, the seat back 246, the seat frame 210, the partition 214, the stanchion 218, the handrail 219, the floor 222 and 226, side panels 230 and 234, and the ceiling 238. With the selected carrier interior components being adorned with the selected 182 fabric style 146 or selected color 170, or fabric texture 159 or color texture 203 as applicable that is associated with the selected carrier interior space component as previously defined.

Further, as another option to the method 30 for the selecting step 182 as previously described, could be modified to a selecting step 183 that includes selecting manually one fabric style 146 or surface color 170. In conjunction with this, an added step of optionally coordinating 258 a fabric style 146 or surface color 170 by automatically selecting a fabric style 146 or surface color 170 that was previously unselected. Then a next step follows of displaying 262 the manually selected fabric style 146 or surface color 170 and the automatically selected fabric style 146 or surface color 170 on their respective associated first carrier interior space component 166 and second carrier interior space component 178, all within the interior space 142. Further, on the coordination 258 or more particularly the coordination 258 of the detailed individual interior design element attributes 154, 158, 159, 194, 198, 202, and 203 by automatically selecting the aforementioned interior design element or plurality of interior design elements from the aforementioned attribute groups for a suggested design theme through a set of criterion to aesthetically match the interior design elements and then display them in any manner of groups of two or more. In other words, the coordination step 258 is operational to “fill in” for the unselected interior design element(s) by automatically facilitating the selecting of one or more interior design elements from their respective attribute groups as defined above associated with their particular interior space components or alternatively the coordination 258 step can select all of the interior design elements according to a theme type criterion as an interior design suggestion for the carrier interior space 142. Therefore the individual using the method 30 could manually select from none to one short of all of the interior design elements available to select from and then utilize the optional coordination 258 step to automatically select from one to all of the interior design elements.

Further the step of displaying a plurality of surface colors 170 is further segregated into a plurality of different attributes 190, with each attribute 194, 198, and 202 having a plurality of surface colors, plus the optional surface color attribute 203 of texture (not shown), with each attribute associated with a specific carrier interior space component 206. Wherein the coordinating step 258 further includes automatically selecting a complementary fabric style 146 or plurality of surface colors 170, that were previously unselected and displaying the manually selected fabric style 146 or the surface colors 170 and the automatically selected fabric style 146 or the surface colors 170 on their respective associated carrier interior space components 206, all within the carrier interior space 142. Further, the selecting step for the surface colors 170 optionally includes carrier interior space 142 components of a seat frame 210, a partition 214, a stanchion 218, a handrail 219, a floor 222 and 226, and a side panel 230 and 234, plus alternatively a ceiling 238.

Another option is to include an added step of generating 266 a bill of materials list 270 based upon the manually and automatically selected fabric style 146 and surface color 170, possibly texture for fabric 159 and surface color 203, also accommodating the quantities of the first 166 and second 178 carrier interior space components 206 to have the bill of materials list supply the entire carrier interior space 142. Further, the bill of materials list 270 could be generated 266 for all or a portion of the interior design components of the seat frame 210 including component 242 for the seat cushion and component 246 for the seat back cushion, the segmented pathway 222 and non-pathway 226 flooring, upper 234 and lower 230 sidewalls, ceilings 238, handrails 219, partitions 214, and stanchions 218, all of which are adorned with the manually and/or automatically selected associated interior design elements chosen from the attributes of fabric patterns 158, fabric textures 159 (not shown), fabric colors 154, surface colors 194, 198, or 202 and textures 203 (not shown). The bill of materials list 270 would be generated through the importation of the information chosen by the user into a template, which could then be electronically communicated through the internet or other means to place an order with a supplier or suppliers.

The aforementioned method 30 can also be an article of manufacture 274, comprising a machine accessible medium 278 having instructions encoded thereon for enabling a processor to perform the operations of the aforementioned method 30 and variations thereof. The article of manufacture 274 can be any form of medium 278 of that can communicate instructions to enable 282 a processor to perform the method 30. Thus the article of manufacture 274 can be a CD, DVD, thumbnail drive, hard disc drive, or any other storage medium that communicates instructions to a processor directly or indirectly.

Referring to FIGS. 5 to 10, the preferred interior design elements, attribute groups, and interior space components associations are given: however, these associations are not to be limiting in any way in that additional interior design elements, additional or fewer attribute groups per interior design element, and additional interior space components having different associations than the following would be acceptable, as the following are given as an example of the preferred interior design method 30 logic. Focusing in particular on FIGS. 5 and 6, starting with the interior design element 42 is preferably selected from an attribute group of a fabric style 146 that further has attribute subgroups of fabric pattern 158, fabric color 154, and/or fabric texture 159 (not shown). In addition, the attribute group of fabric style 146 is associated with the interior space components of the seat 242 and the seat back 246. Continuing for the interior design element of 62 is preferably selected from an attribute group of surface color 170 and/or color texture 203 (not shown) associated with the interior design component of the seat frame 210. Further, the interior design element 90 is selected from the preferred attributes of again surface color 170 with attribute subgroups of the bright color grouping 194 and/or color texture 203 (not shown) associated with interior design component of the stanchion 218. Next, interior design element 143 is associated with and selected from the attributes of basic colors 202 and/or color texture 203 (not shown) for the interior design component of the partition 214. Continuing, interior design element 144 is associated with and selected from attributes of basic colors 202 and/or texture 203 (not shown) for the interior design component of the center floor 222.

Next, interior design element 145 is associated with and selected from attributes of basic colors 202 and/or texture 203 (not shown) for the interior design component of the side floor 226. Continuing, interior design element 147 is associated with and selected from attributes of pastel colors 198 and/or texture 203 (not shown) for the interior design component of the lower side panel 230. Further continuing, interior design element 148 is associated with and selected from attributes of pastel colors 198 and/or texture 203 (not shown) for the interior design component of the upper side panel 234. Next, interior design element 149 is associated with and selected from attributes of bright colors 194 and/or texture 203 (not shown) for the interior design component of the handrail 219, although handrail 219 is not shown in the manual selection function frame 36, however the handrail 219 is shown as the interior design component 219 in FIG. 5. Continuing, interior design element 151 is associated with and selected from attributes of pastel colors 198 and/or texture 203 (not shown) for the interior design component of the ceiling 238, although ceiling 238 is not shown in the manual selection function frame 36, however the ceiling 238 is shown as the interior design component 238 in FIGS. 5 and 7.

Incorporation by reference to the specification for the source code as follows:
Source code is submitted as a CD under separate cover as U.S. Express Mail ED 887532086 US, Mailed on Feb. 22, 2008
File name: Computer Listing Feb. 22, 2008
File size (MB): 111, 60 separate files
File creation date (original): Oct. 13, 2007
File format: Macromedia Flash Player 6 and Shockwave Flash Object
File description: Source code for carrier design system

### CONCLUSION

Accordingly, the present invention of a method 30 for designing an interior space 34 has been described with some degree of particularity directed to the embodiment(s) of the present invention. It should be appreciated, though; that the present invention is defined by the following claims construed in light of the prior art so modifications or changes may be made to the exemplary embodiment(s) of the present invention without departing from the inventive concepts contained therein.

1. A method of designing an interior space having a plurality of components, comprising:
(a) displaying a plurality of interior design elements each having a common first attribute within a group defined by said first attribute, with said first attribute being associated with a first interior space component;
(b) displaying a plurality of interior design elements each having a common second attribute within a group defined by said second attribute, with said second attribute being associated with a second interior space component;
(c) selecting one said interior design element from each of said group defined by said first attribute and said second attribute; and
(d) displaying each one of said selected interior design elements from said first attribute group and said second attribute group on their respective associated first interior space component and second interior space component, all within the interior space.

2. A method of designing an interior space according to claim 1 further comprising a step of displaying a plurality of interior design elements each having a common third attribute within a group defined by said third attribute that is associated with a third interior space component, wherein one of said interior design elements is selected from said third attribute group and further displaying said selected interior design element from said third attribute group on the third interior space component within the interior space.

3. A method of designing an interior space according to claim 1 further comprising a step of selectively displaying a selected interior space component independent of the interior space, wherein the selected interior space component is adorned with said selected interior design element that is associated with the selected interior space component.

4. A method of designing an interior space according to claim 1 further comprising a step of sequentially repeating said steps (c) and (d).

5. A method of designing an interior space having a plurality of components, comprising:
(a) displaying a plurality of interior design elements each having a common first attribute within a group defined by said first attribute, with said first attribute being associated with a first interior space component;
(b) displaying a plurality of interior design elements each having a common second attribute within a group defined by said second attribute, with said second attribute being associated with a second interior space component;
(c) selecting manually one said interior design element from either said first attribute group or said second attribute group;
(d) coordinating a pair of interior design elements by automatically selecting an interior design element from said attribute group that did not have an interior design element previously selected from; and
(e) displaying said manually selected interior design element and said automatically selected interior design element on their respective associated first interior space component and second interior space component, all within the interior space.

6. A method of designing an interior space according to claim 5 further comprising a step of displaying a plurality of interior design elements each having a common third attribute within a group defined by said third attribute that is associated with a third interior space component, wherein an interior design element is manually selected from one of said first, second, or third attribute groups, wherein a plurality of interior design elements from their respective attribute groups and on their respective interior space components are displayed from coordinating an automatic selection of said interior design elements from said attribute groups that did not have an interior design element previously manually selected.

7. A method of designing an interior space according to claim 5 further comprising a step of selectively displaying a selected interior space component independent of the interior space, wherein the selected interior space component is adorned with said selected interior design element that is associated with the selected interior space component.

8. A method of designing an interior space according to claim 5 further comprising a step of sequentially repeating said steps (c), (d), and (e).

9. A method of designing a carrier interior space, comprising:
(a) displaying a plurality of fabric styles associated with a first carrier interior space component;
(b) displaying a plurality of surface colors associated with a second carrier interior space component;
(c) selecting one said fabric style and one said surface color; and
(d) displaying each one of said selected fabric styles and said selected surface colors that are associated with their respective carrier interior space components to visually perceive the carrier interior with said selected fabric styles and said selected surface colors.

10. A method of designing a carrier interior space according to claim 9 wherein said step of displaying a plurality of surface colors is further segregated into a plurality of different attributes, with each said attribute having a plurality of surface colors, with each said attribute associated with a specific carrier interior space component, wherein said selecting step further includes selecting a plurality of surface colors, being a selection of a surface color for each said specific carrier interior space component.

11. A method of designing a carrier interior space according to claim 10 wherein said selecting step for said surface colors includes carrier interior space components of a seat frame, a partition, a stanchion, a handrail, a floor, and a side panel.

12. A method of designing a carrier interior space according to claim 9 further comprising a step of selectively displaying a selected carrier interior space component independent of the carrier interior space, wherein the selected carrier interior space component is adorned with said selected fabric style or selected color that is associated with the selected carrier interior space component.

13. A method of designing a carrier interior space according to claim 9 further comprising a step of sequentially repeating said steps (c) and (d).

14. A method of designing a carrier interior space, comprising:
(a) displaying a plurality of fabric styles associated with a first carrier interior space component;
(b) displaying a plurality of surface colors associated with a second carrier interior space component;
(c) selecting manually one said fabric style or one said surface color;
(d) coordinating said fabric styles and said surface colors by automatically selecting a complementary said fabric style or said surface color that was previously unselected; and
(e) displaying said manually selected said fabric style or said surface color and said automatically selected said fabric style or one said surface color on their respective associated first carrier interior space component and second carrier interior space component, all within the carrier interior space.

15. A method of designing a carrier interior space according to claim 14 wherein said step of displaying a plurality of surface colors is further segregated into a plurality of different attributes, with each said attribute having a plurality of surface colors, with each said attribute associated with a specific carrier interior space component, wherein said coordinating step further includes automatically selecting a complementary fabric style or said plurality of surface colors, that were previously unselected and displaying said manually selected said fabric style or said surface colors and said automatically selected said fabric style or said surface colors on their respective associated carrier interior space components, all within the carrier interior space.

16. A method of designing a carrier interior space according to claim 15 wherein said selecting step for said surface colors includes carrier interior space components of a seat frame, a partition, a stanchion, a handrail, a floor, and a side panel.

17. A method of designing an interior space according to claim 14 further comprising a step of selectively displaying a selected carrier interior space component independent of the interior space, wherein the selected carrier interior space component is adorned with said manually or automatically selected fabric style or surface color that is associated with the selected carrier interior space component.

18. A method of designing an interior space according to claim 14 further comprising a step of sequentially repeating said steps (c), (d), and (e).

19. A method of designing a carrier interior space, comprising:
(a) displaying a plurality of fabric styles associated with a first carrier interior space component;
(b) displaying a plurality of surface colors associated with a second carrier interior space component;
(c) selecting manually one said fabric style or one said surface color;
(d) coordinating said fabric styles and said surface colors by automatically selecting a complementary said fabric style or said surface color that was previously unselected;
(e) displaying said manually selected said fabric style or said surface color and said automatically selected said fabric style or one said surface color on their respective associated first carrier interior space component and second carrier interior space component, all within the carrier interior space; and
(f) generating a bill of materials list based upon said manually and automatically selected fabric style and surface color also accommodating the quantities of the first and second carrier interior space components to have said bill of materials list supply the entire carrier interior space.

20. A method of designing a carrier interior space according to claim 19 wherein said step of displaying a plurality of surface colors is further segregated into a plurality of different attributes, with each said attribute having a plurality of surface colors, with each said attribute associated with a specific carrier interior space component, wherein said coordinating step further includes automatically selecting a complementary fabric style or said plurality of surface colors, that were previously unselected and displaying said manually selected said fabric style or said surface colors and said automatically selected said fabric style or said surface colors on their respective associated carrier interior space components, all within the carrier interior space.

21. A method of designing a carrier interior space according to claim 20 wherein said selecting step for said surface colors includes carrier interior space components of a seat frame, a partition, a stanchion, a handrail, a floor, and a side panel and said generating step for said bill of materials includes said carrier interior space components.

22. An article of manufacture, comprising a machine accessible medium having instructions encoded thereon for enabling a processor to perform the operations of:
(a) displaying a plurality of fabric styles associated with a first carrier interior space component;
(b) displaying a plurality of surface colors associated with a second carrier interior space component;
(c) selecting manually one said fabric style or one said surface color;
(d) coordinating said fabric styles and said surface colors by automatically selecting a complementary said fabric style or said surface color that was previously unselected; and
(e) displaying said manually selected said fabric style or said surface color and said automatically selected said fabric style or one said surface color on their respective associated first carrier interior space component and second carrier interior space component, all within the carrier interior space.
